(19) United States
(12) Patent Application Publication
(10) Pub. No.: US 2025/0274365 A1
(43) Pub. Date: Aug. 28, 2025

(54) RESOURCE ANOMALY DETECTION

(71) Applicant: Microsoft Technology Licensing, LLC, Redmond, WA (US)

(72) Inventor: Hagit GRUSHKA, Beer-Sheva (IL)

(73) Assignee: Microsoft Technology Licensing, LLC, Redmond, WA (US)

(21) Appl. No.: 19/209,176

(22) Filed: May 15, 2025

Related U.S. Application Data
(63) Continuation of application No. 18/148,529, filed on Dec. 30, 2022.

(51) Int. Cl. H04L 43/08; H04L 41/0631; H04L 41/16; H04L 43/04; H04L 43/16

(52) U.S. Cl. CPC H04L 43/08; H04L 41/0631; H04L 41/16; H04L 43/04; H04L 43/16

(57) ABSTRACT

Systems and methods for detecting an unstable resource of a cloud service. A set of health time-series data of a first resource is received and a resource behavior model trained on historical health time-series data of resources of a same type as the first resource is used to encode the received data into embeddings. In some examples, the model reconstructs the embeddings, compares the embeddings to the received data, and determines a reconstruction loss value for determining whether the first resource is operating in an anomalous behavior state. In some examples, the generated embeddings are compared to embeddings generated from health time-series data received from other resources of a same type as the first resource. A similarity-score is determined and used to determine whether the first resource is operating in an anomalous behavior state. The system and method further report anomalous behavior, indicating the first resource is unstable or unhealthy.

### CROSS-REFERENCE TO RELATED APPLICATIONS

This application is a continuation of U.S. patent application Ser. No. 18/148,529 filed Dec. 30, 2022, entitled “Resource Anomaly Detection,” which is incorporated herein by reference in its entirety.

### BACKGROUND

Cloud services use various cloud resources to support the services. Service owners in cloud computing often define thousands of metrics for monitoring their service and resource health. In some examples, temporal anomaly detection is used on resource alert logs for root cause analysis of cloud systems. Some cloud systems are configured in such a way that the cloud system has jittery or otherwise loud behavior that can obfuscate temporal anomaly detection and prevent detection of an unstable resource.

It is with respect to these and other considerations that examples have been made. In addition, although relatively specific problems have been discussed, it should be understood that the examples should not be limited to solving the specific problems identified in the background.

### SUMMARY

Examples described in this disclosure relate to systems and methods for providing resource health analysis for determining resource stability. Systems and methods include training an embedding model on historical health time-series data of resources of a same type. Systems and methods further include receiving a set of health time-series data of a resource of interest and using the model to encode the received data into embeddings. In some examples, the model further reconstructs the embeddings, which are compared to the received data for determining a reconstruction loss value. For example, the reconstruction loss value allows for determining whether the resource of interest is operating in an expected or in an anomalous behavior state. In some examples, the generated embeddings are compared to embeddings generated from health time-series data received from other resources of a same type as the resource of interest. A similarity-score is determined and used to determine whether the resource of interest is operating in an expected or an anomalous behavior state. The system and method further report anomalous behavior, indicating the resource of interest is unstable.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

### BRIEF DESCRIPTION OF THE DRAWINGS

The present disclosure is illustrated by way of example by the accompanying figures, in which like references indicate similar elements. Elements in the figures are illustrated for simplicity and clarity and have not necessarily been drawn to scale.

FIG. 1 is a block diagram of a system in which an anomaly detection system is implemented according to an example;

FIG. 2 is a block diagram illustrating generation of a resource behavior model according to an example;

FIG. 3 is a block diagram illustrating execution of a resource behavior model for detecting resource stability according to an example;

FIG. 4 is a block diagram illustrating execution of a resource behavior model for determining resource stability according to another example;

FIG. 5 is a flowchart depicting operations of an example method for determining resource stability;

FIG. 6 is a block diagram illustrating example physical components of a computing device with which aspects of the disclosure may be practiced;

FIGS. 7A and 7B are block diagrams of a mobile computing device with which aspects of the present disclosure may be practiced; and

FIG. 8 is a simplified block diagram of an example distributed computing system for practicing aspects of the present disclosure.

### DETAILED DESCRIPTION

Examples described in this disclosure relate to systems and methods for providing resource health analysis for detecting resource stability. A cloud service uses various types of cloud resources (e.g., applications, devices, storage, processing power, networking, analytics, intelligence) that support operation of the service. Temporal anomaly detection is oftentimes used to monitor collected resource alert data (e.g., logs of occurrences of monitored event types) to determine whether a resource used by the cloud service is behaving as expected. In various examples, a first analysis system is used to derive a time series of resource alert data and evaluate the time series against “expected” resource alert data, where a deviation from the expected resource alert data may indicate an anomaly. The term “expected” is herein used to describe data that has been previously collected, is indicative of typical or baseline behavior, and/or occurs regularly or predictable over a timeframe. For instance, comparing data points in a current timeframe (X) to a distribution viewed during one or more previous time frames (X₁, X₂, . . . Xₙ) may reveal an outlier in the current timeframe. Such outliers are anomalous points in time where the resource is suspected of being unstable (e.g., suspected of being unhealthy or otherwise operating or performing in an unexpected way).

In some cases, “noisy” resource alert data can obfuscate anomalous resource behavior. For instance, the resource may have jittery behavior due to the service being configured in such a way that the service requires more resources than have been allotted for the service. This misconfiguration of the service causes the resource to behave in a noisy manner, where a large number of notifications of a monitored event type are reported in collected resource health data for the resource. Such behavior may be determined as representing an expected health state for the resource using temporal anomaly detection methods of the first analysis system, where the regular reporting of event notifications may obfuscate an underlying abnormality of behavior for the resource or for a particular resource type.

Thus, examples of the present disclosure describe a second analysis system and method for identifying stability of a resource that may appear as behaving normally, such as when the resource's normal behavior is unstable. According to examples, a resource behavior model is trained on historical health time-series data of a particular resource type, where the historical health time-series data represents expected operating behavior of resources of the particular resource type over one or more periods of time in the past. As an example, the historical health time-series data includes a collection of observations obtained through repeated measurements (metrics) over a time period. For instance, metric values represent values of measurements of resource usage or behavior that are observed and collected. Examples of metrics include temperature measurements, CPU consumption measurements, memory consumption measurements, and the like. In some examples, the resource behavior model is an autoencoder trained to encode and/or decode data similar to the data on which it has been trained.

In some examples, a set of health time-series data of a resource of interest is received and the resource behavior model is used to encode the set of health time-series data into a set of embeddings. In some examples, the resource behavior model is further used to convert the embeddings back to a reconstruction of the original health time-series data. For example, the reconstructed health time-series data is compared to the received health time-series data and a reconstruction loss value is determined for determining whether the resource of interest is operating in an expected behavior state or an anomalous behavior state.

In some examples, the embeddings generated from the received health time-series data are compared to embeddings generated from health time-series data received in association with other resources of the same resource type as the resource of interest. In some examples, a measure of the similarity between the resource of interest's embeddings and the embeddings of other resources is determined and used for determining whether the resource of interest is operating in an expected behavior state or an anomalous behavior state. In some examples, when an anomalous behavior state(s) is determined, examples of the present disclosure further include reporting the anomalous behavior. For example, an alert is generated indicating the resource of interest is unstable.

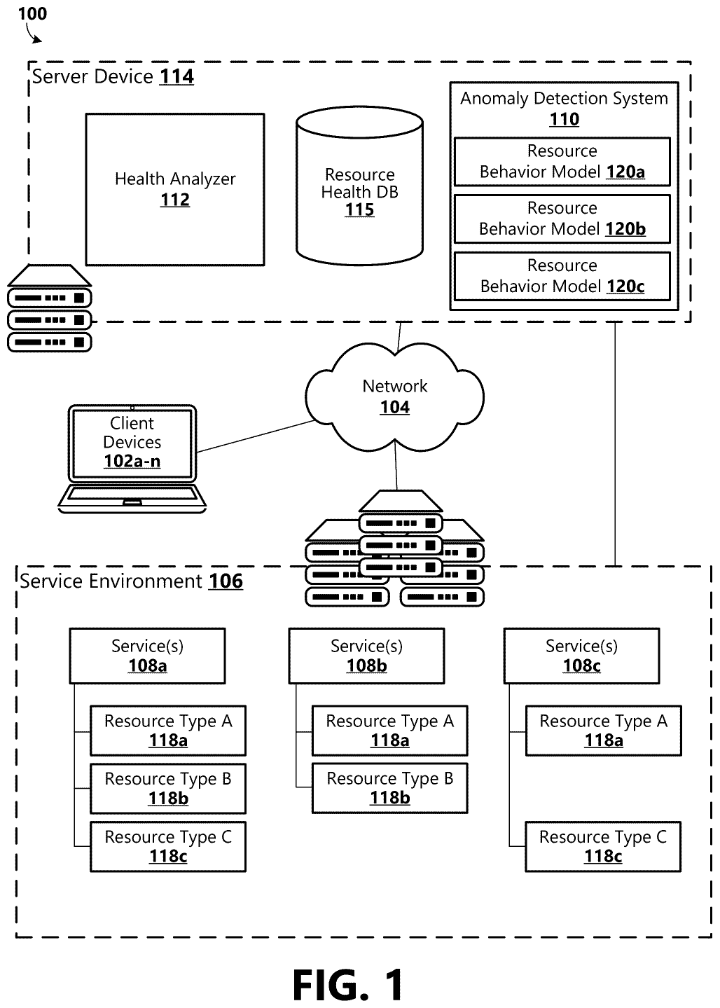

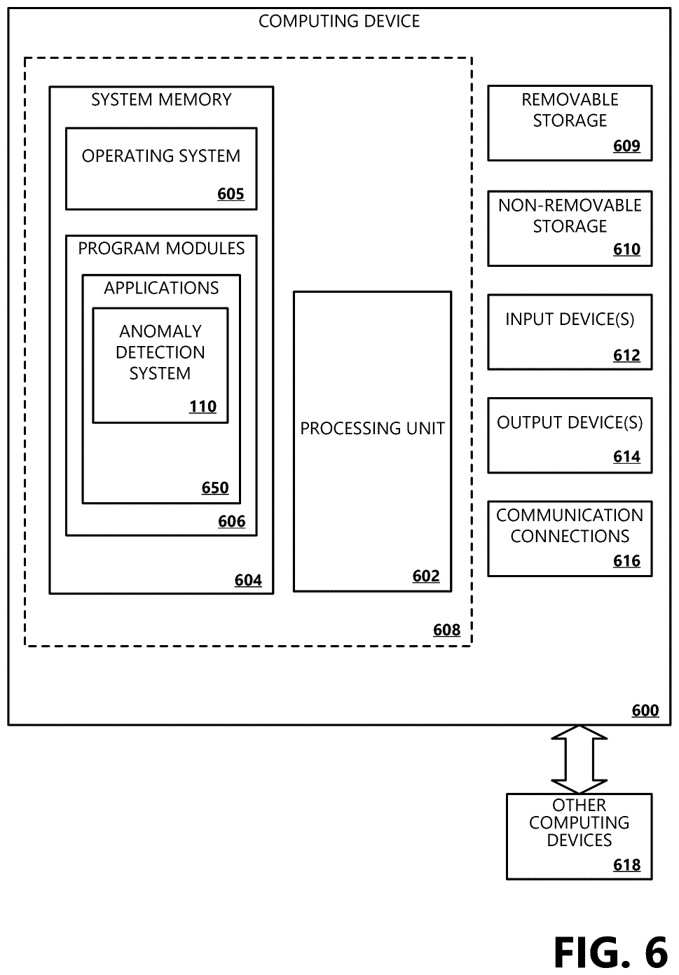

FIG. 1 is a block diagram of an example system 100 for detecting anomalous resource behavior. The example system 100 as depicted is a combination of interdependent components that interact to form an integrated whole. Components of the system 100 are illustrative of software applications, systems, or modules that operate on a computing device or across a plurality of computer devices. Any suitable computer device(s) may be used, including web servers, application servers, network appliances, dedicated computer hardware devices, virtual server devices, personal computers, a system-on-a-chip (SOC), or any combination of these and/or other computing devices known in the art. In one example, components of systems disclosed herein are implemented on a single processing device. The processing device may provide an operating environment for software components to execute and utilize resources or facilities of such a system. An example of processing device(s) comprising such an operating environment is depicted in FIGS. 6-8. In another example, the components of systems disclosed herein are distributed across multiple processing devices. For instance, input may be entered on a user device or client device and information may be processed on or accessed from other devices in a network, such as one or more remote cloud devices or web server devices.

In FIG. 1, the system 100 includes client devices 102a-n (collectively “client device(s) 102”), a network 104, a service environment 106 including a plurality of computing service(s) 108a-108c (collectively “service(s) 108”) and resources 118a-118c (collectively, “resources 118”), and one or more server devices 114 comprising an anomaly detection system 110, a source or resource health analyzer 112, and a health database 115. One of skill in the art will appreciate that the scale and structure of systems such as system 100 may vary and may include additional or fewer components than those described in FIG. 1. In one example, the service environment 106, one or more service(s) 108, and/or one or more resources 118 are incorporated into a client device(s) 102 or the server device 114. In another example, the health analyzer 112, the anomaly detection system 110, and the resource health database 115 operate in the service environment 106. Further, the number of services 108 and resources 118 in the service environment 106 may vary.

The client device(s) 102 detect and/or collect input data from one or more users or peripheral devices. In some examples, the input data corresponds to user interaction with one or more software applications or services implemented by, or accessible to, the client device(s) 102. In other examples, the input data corresponds to automated interaction with the software applications or services, such as the automatic (e.g., non-manual) execution of scripts or sets of commands at scheduled times or in response to predetermined events. The user interaction or automated interaction may be related to the performance of user activity corresponding to a task, a project, a data request, or the like. The input data may include, for example, audio input, touch input, text-based input, gesture input, and/or image input. The input data is detected/collected using one or more sensor components of client device(s) 102. Examples of sensors include microphones, touch-based sensors, geolocation sensors, accelerometers, optical/magnetic sensors, gyroscopes, keyboards, and pointing/selection tools. Examples of client device(s) 102 include personal computers (PCs), mobile devices (e.g., smartphones, tablets, laptops, personal digital assistants (PDAs)), wearable devices (e.g., smart watches, smart eyewear, fitness trackers, smart clothing, body-mounted devices, head-mounted displays), and gaming consoles or devices, and Internet of Things (IoT) devices.

In various implementations, the client device(s) 102 provide the input data to the service environment 106. In some examples, the input data is provided to the service environment 106 using the network 104. Examples of the network 104 include one or a combination of a private area network (PAN), a local area network (LAN), a wide area network (WAN), and the like. For instance, although the network 104 is depicted as a single network, it is contemplated that the network 104 may represent several networks of similar or varying types. In some examples, the input data is provided to the service environment 106 without using the network 104.

The service environment 106 provides the client device(s) 102 access to various services 108 and resources 118. In examples, the service(s) 108 provide access to a set of software and/or hardware functionality. Examples of service(s) 108 include virtual meeting services, topic detection and/or classification services, data domain taxonomy services, expertise assessment services, content detection services, audio signal processing services, word processing services, spreadsheet services, presentation services, document-reader services, social media software or platforms, search engine services, media software or platforms, multimedia player services, content design software or tools, database software or tools, provisioning services, and alert or notification services. In examples, the resources 118 provide access to various sets of software and/or hardware functionalities that support the services 108 (e.g., dependencies of the services 108). Example types of resources 118 include artificial intelligence (AI) and machine learning (ML) resources, analytics resources, compute resources, containers resources, database resources, developer tool resources, identity resources, integration resources, Internet of Things (IoT) resources, management and governance resources, media resources, migration resources, mixed reality resources, mobile resources, networking resources, security resources, storage resources, virtual desktop infrastructure resources, and web resources. Other types of services 108 and resources 118 are possible and are within the scope of the present disclosure.

In aspects, the service environment 106 includes or provides access to various services 108 and supporting resources 118. In some examples, the service environment 106 is implemented in a cloud-based or server-based environment using one or more computing devices, such as server devices (e.g., web servers, file servers, application servers, database servers), edge computing devices (e.g., routers, switches, firewalls, multiplexers), personal computers (PCs), virtual devices, and mobile devices. In other examples, the service environment 106 is implemented in an on-premises environment (e.g., a home or an office) using such computing devices. In some implementations, the service environment 106 includes numerous hardware and/or software components and is subject to one or more distributed computing models/services (e.g., Infrastructure as a Service (IaaS), Platform as a Service (PaaS), Software as a Service (SaaS), Functions as a Service (FaaS)). In some examples, services 108 and resources 118 are integrated into (e.g., hosted by or installed in) the service environment 106. Alternatively, one or more service(s) 108 and/or resources 118 are implemented externally to the service environment 106. For instance, one or more service(s) 108 and/or resources 118 may be implemented in a service environment separate from the service environment 106 or in client device(s) 102.

According to example implementations, health data of services 108 and/or resources 118 in the service environment 106 are collected over a time period and are used to monitor the health of the service environment 106. As an example, the health data comprises metrics corresponding to repeated measurements taken over the time period. The metrics of the temporal health data are numerical values that are collected at regular intervals (e.g., once every N seconds, once a minute, once every N minutes) from services 108 and/or resources 118 and describe an aspect (e.g., usage and/or behavior) of the service 108 and/or resource 118 at a particular time.

According to examples, the health database 115 receives and stores health data for services 108 and resources 118, where the health database 115 is optimized for analyzing time-stamped data. For instance, time-series data is used to analyze service/resource metrics from a time perspective. Thus, in some examples, metric values are transformed into an ordered series of numeric metric values (sometimes referred to herein as health time-series data) that are stored in the health database 115. In some examples, each set of metric values is a time series including the following properties: a time when the value was collected, a resource 118 associated with the value, a namespace that acts as a category for the metric, a metric name, a metric value, a metric sampling type, and one or more dimensions when they are present. According to an example, health data has metric/value pairs, such as CPU used=70%, where “CPU usage” is the metric and “70%” is the value of the metric.

In some examples, the health analyzer 112 represents a first analysis system that monitors health time-series data for detecting and alerting to a change in health state of a corresponding resource 118. Such a change in health state is referred to as a resource event. In some examples, a resource event is associated with a resource performance issue, outage, or other resource interruption or unavailability occurring at a point in time. For example, the health analyzer 112 performs a temporal anomaly analysis to detect anomalous points in time where the resource 118 is suspected of being unstable. For instance, healthy systems have metric values that are steady, predictable, and exhibit a regular pattern. When a resource event occurs, the resource event is represented as an anomaly or outlier in performance telemetry from the resource 118, where an anomalous pattern/outlier of metrics characterizes the resource event. For instance, a metric that increases (or otherwise behaves differently) during or in response to the occurrence of a resource incident is an example of an outlier or an anomalous pattern of the metric. In some examples, the health analyzer 112 generates an incident report to provide information about a diagnosed service/resource event. In some implementations, the health analyzer 112 further performs a root cause analysis for the service or resource event and the incident report includes information about a determined root cause of the service/resource event.

As mentioned above, in some examples, anomalous behavior of a resource 118 can sometimes be obfuscated or otherwise be undetectable by the health analyzer 112. Accordingly, in some examples, the analysis system includes a second analysis system comprising the anomaly detection system 110 represents a second analysis system that detects resource stability using one or more resource behavior models 120a-120c (collectively, “resource behavior models 120”) trained on historical health time-series data. Historical health time-series data, for example, includes resource health data related to expected operating behavior of resources 118 over one or more periods of time in the past. In some examples, each resource behavior model 120 is trained on historical health time-series data corresponding to a particular type or class of resource 118. In some examples, each resource behavior model 120 includes an autoencoder trained to encode and/or decode data similar to the data it has been trained on (e.g., a first resource behavior model 120a is trained for resource type A 118a, a second resource behavior model 120b is trained for resource type B 118b, and a third resource behavior model 120c is trained for resource type C 118c). In other examples, a resource behavior model 120 includes an autoencoder trained to encode and/or decode data of various types of resources 118.

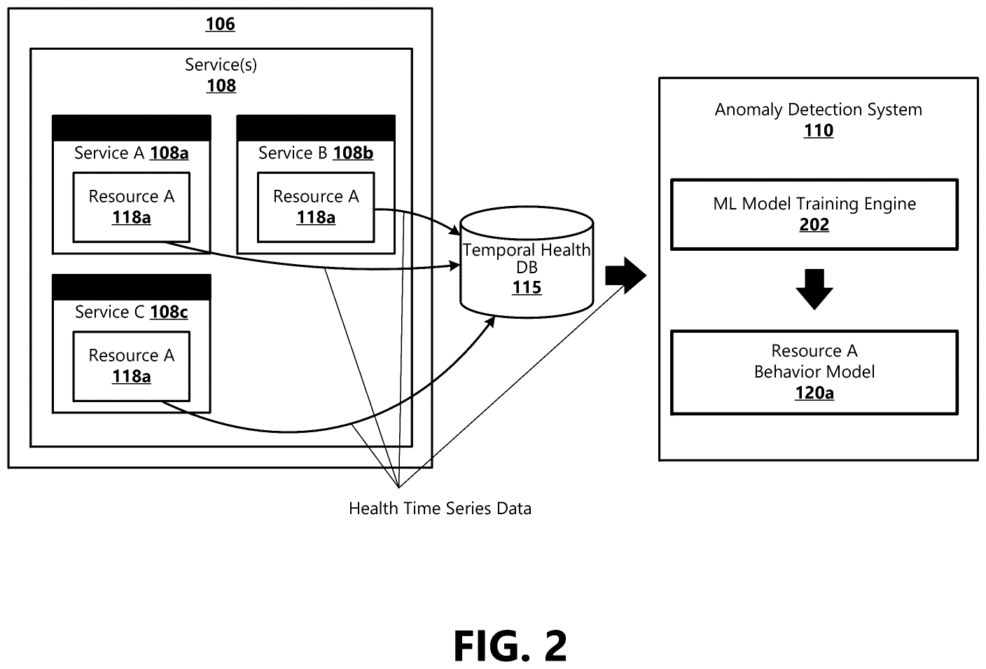

With reference now to FIG. 2, a diagram is shown illustrating generation of an example resource behavior model 120 for a particular resource type according to an example implementation. As shown, health data is collected from different resources 118 of a same type (e.g., type A resources 118a) that operate to support different services 108 (e.g., service A 108a, service B 108b, and service C 108c) in a service environment 106. The health data for the type A resources 118a is collected over an extended time period and stored in the health database 115 as health time-series data. As depicted, in some examples, the anomaly detection system 110 includes a ML model training engine 202 that trains a first resource behavior model 120a on historical health time-series data for the type A resources 118a collected over the time period. For instance, the first resource behavior model 120a captures characteristics of the health time-series data for a plurality of type A resources 118a. The plurality of type A resources 118a, for example, share a common operational and/or behavior pattern, where expected behavior of the plurality of type A resources 118a over the time period is captured in the historical temporal data. Thus, a resource's health time-series data can be compared to this expected behavior of resources 118 of the same class/type. As an example, the first resource behavior model 120a is trained to predict expected time-series data behavior for resources 118 of a first type or class (e.g., storage resources). A second resource behavior model 120 is trained to predict expected time-series data behavior for resources 118 of a second type or class (e.g., identity resources) and the third resource behavior model 120 is trained to predict expected time-series data behavior for resources 118 of a third type or class (e.g., networking resources). For instance, each resource behavior model 120 is trained to learn about relationships between resource health data metrics corresponding to the particular resource type.

In some examples, the resource behavior models 120 are autoencoders including an encoder layer and a decoder layer. The encoder layer is trained to generate embeddings of a set of received temporal health data of a resource 118. In some implementations, the encoder layer of the resource behavior models 120 reduces the dimensionality of the received health time-series data. The embeddings express relationships between the health data metrics of a resource type as weighted vectors between the metrics. In some implementations, the decoder layer of the resource behavior models 120 is trained to reconstruct expected health time-series data with minimal loss. As will be described in further detail below, in some examples, the anomaly detection system 110 uses the resource behavior models 120 to detect when a resource 118 is behaving abnormally (e.g., differently than predicted/expected) by comparing the reconstructed health time-series data to the received health time-series data for determining a loss. When the loss is above a threshold value, a state of anomalous resource behavior is determined. For instance, when health data metrics that characterize anomalous resource behavior are included in received health time-series data, the resource behavior model 120 will not be familiar with the anomalous metrics and the decoder layer will have trouble reproducing the received health time-series data with learned weights of the expected data. Accordingly, the subsequent reconstruction loss will be higher than the threshold and the anomaly detection system 110 determines a state of anomalous behavior of the resource 118. According to examples, the anomaly detection system 110 is able to determine that the resource 118 is unstable without pointing to a specific moment in time, such as methods performed by the resource health analyzer 112. Some example types of loss functions used by the anomaly detection system 110 include mean squared error and Kullback-Leibler divergence. Other types of loss functions are possible and are within the scope of the present disclosure.

In some examples, the anomaly detection system 110 is configured to use the encoder layer of the resource behavior models 120 to generate embeddings of a set of received health time-series data of a first resource 118 and compare the generated embeddings with a library of embeddings of other resources 118 of the same type as the first resource 118 to detect anomalous resource behavior. For instance, the anomaly detection system 110 determines a similarity measure between the embeddings of the first resource 118 to the library of embeddings. When the similarity measurement is outside a similarity threshold, the anomaly detection system determines a state of anomalous behavior of the resource 118. Some example similarity measurements include Euclidean distance, cosine similarity, and dot product. In some examples, when an anomalous behavior state of a resource 118 is detected, the anomaly detection system 110 generates an alert, where the alert indicates the resource 118 is possibly unstable.

In some examples, the health analyzer 112 identifies a data event as anomalous, where the data event may not actually be anomalous when considered against data events of other resources 118 of the same type. As an example, a first resource 118 of a first resource type (Type A) causes CPU usage of a service to spike to 90% between 9 μm and 10 pm every night. In the context of the first resource, the spike appears anomalous in a normal 24-hour period where the CPU usage of the service does not otherwise exceed 50%. Thus, the health analyzer 112 marks the first resource 118 as unstable. However, when evaluating the first resource 118 against many other resources 118 of the same type that are supporting other services 108, the other resources may also cause the CPU usage of the other services 108 to spike at 9 pm. Thus, the anomaly detection system 110 determines that the first resource 118 is operating in a normal behavior state, where an apparent temporal anomaly may be determined as expected and not corresponding to an unstable resource.

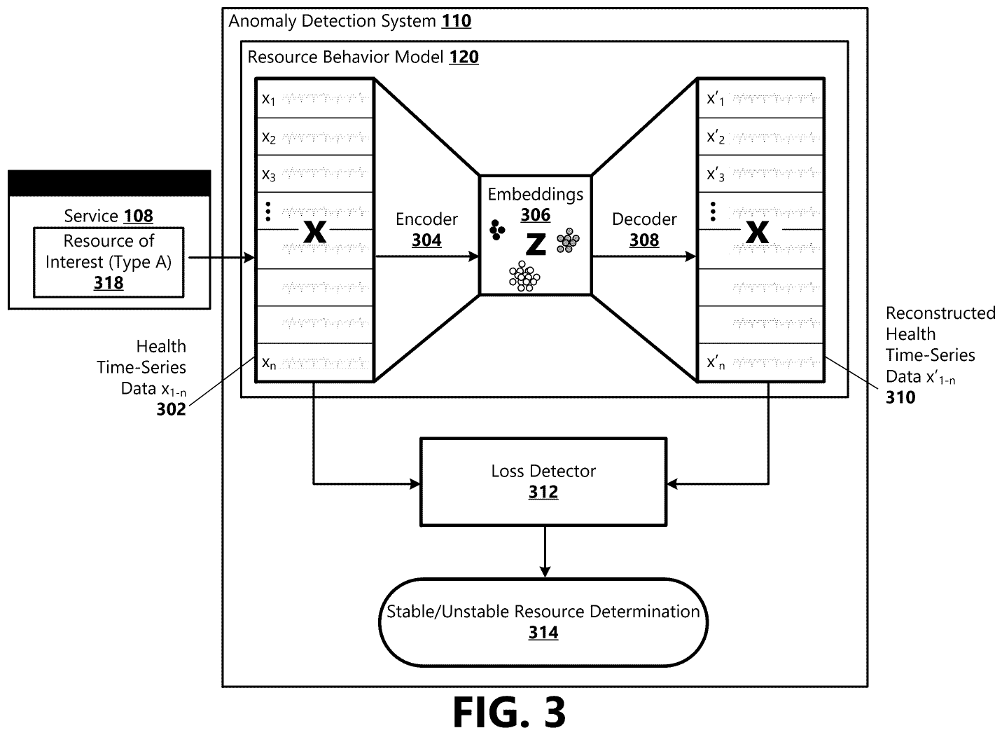

FIG. 3 is a block diagram illustrating execution of an example resource behavior model 120 for determining resource stability according to an example implementation. With reference now to FIG. 3, the anomaly detection system 110 receives a set of health time-series data 302 of a resource 118 of interest (sometimes referred to herein as a resource of interest 318). In some examples, prior to receiving the health time-series data 302, the health time-series data 302 is first collected in a monitoring data store. As depicted, in some examples, the health time-series data 302 is represented as vector time series of metrics collected at regular intervals (e.g., once every N seconds, once a minute, once every N minutes) from the resource of interest 318 of type A. A dimension size of the received health time-series data 302 is represented by “n”. For example, the received set of health time-series data 302 includes a plurality of dimensions, where each dimension represents a plurality of metrics (e.g., temperature metrics, CPU consumption metrics, memory consumption metrics) over a time period. According to an example, a resource behavior model 120 is trained on historical health time-series data 302 of a plurality of resources of a same type (e.g., type A) as the resource of interest 318. The example resource behavior model 120 includes an encoder layer (sometimes referred to herein as an encoder 304) that maps the received health time-series data 302 into a set of embeddings 306 (represented in FIG. 3 as “z”). For instance, the embeddings 306 are weighted embedding vectors that capture various features of the resource behavior data. In some examples, the set of embeddings 306 has a second dimension size represented by “k”. where the second dimension size (k) is less than the first dimension size (n). For instance, the encoder 304 maps the set of received health time-series data 302 to a compressed feature representation of the received data.

The example resource behavior model 120 depicted in FIG. 3 further includes a decoder layer (sometimes referred to herein as a decoder 308) that converts the set of embeddings 306 back to a reconstruction of the original received health time-series data (herein referred to as reconstructed temporal health data 310). For example, the reconstructed temporal health data 310 is represented as vector time series of metrics, where the dimension size of the reconstructed temporal health data 310 is the same as the first dimension size (n).

The anomaly detection system 110 depicted in FIG. 3 further includes a loss detector 312. The loss detector 312 applies a loss function to determine whether differences between the reconstructed health time-series data 310 and the received health time-series data 302 for the resource of interest 318 are above a loss threshold. For example, when the loss detector 312 determines a loss between the reconstructed health time-series data 310 and the received temporal health time-series data 302 is above a threshold distance, a determination 314 is made that the resource of interest 318 is unstable (e.g., unhealthy). Alternatively, when the loss is determined to be below the threshold distance, a determination 314 is made that the resource of interest 318 is stable (e.g., healthy).

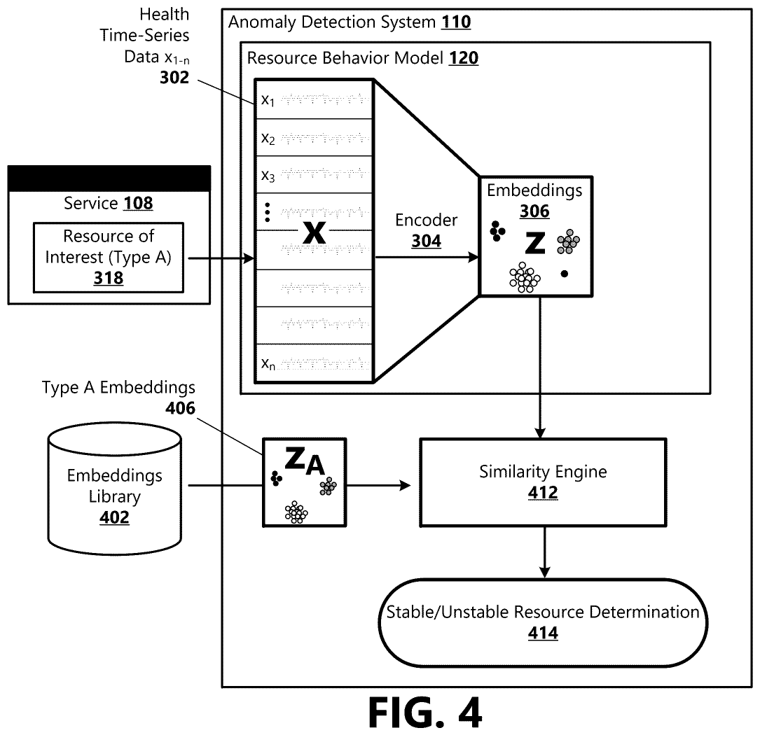

FIG. 4 is a block diagram illustrating execution of an example resource behavior model 120 for determining resource stability according to another example implementation. With reference now to the example anomaly detection system 110 depicted in FIG. 4, the anomaly detection system 110 receives a set of health time-series data 302 of a resource of interest 318. In some examples, prior to receiving the health time-series data 302, the health time-series data 302 is first collected in a monitoring data store. As depicted, in some examples, the health time-series data 302 is represented as a vector time series of metrics collected at regular intervals (e.g., once every N seconds, once a minute, once every N minutes) from the resource A with a dimension size represented by “n”. For example, the received set of health time-series data 302 includes a plurality of dimensions, where each dimension represents a plurality of metrics (e.g., temperature metrics, CPU consumption metrics, memory consumption metrics) over a time period. According to an example, a resource behavior model 120 is trained on historical health time-series data 302 of a plurality of resources of a same type (e.g., type A) as the resource of interest 318. The example resource behavior model 120 includes an encoder 304 that maps the received health time-series data 302 into a set of embeddings 306. For instance, the embeddings 306 are weighted embedding vectors that capture various features of the resource behavior data. In some examples, the set of embeddings 306 has a second dimension size (k), where the second dimension size (k) is less than the first dimension size (n). For instance, the encoder 304 maps the set of received health time-series data 302 to a compressed feature representation of the received data.

The example resource behavior model 120 depicted in FIG. 4 does not include or otherwise does not apply a decoder to the generated first set of embeddings 306. Rather, in some examples, the service device 114 includes or accesses a library of embeddings (referred to herein as an embeddings library 402) to obtain a second set of embeddings 406 (represented in FIG. 4 as “z_{A}”), where the second set of embeddings 406 includes embeddings 406 generated from temporal health data received in association with one or more other resources 118 of the same resource type (e.g., type A) as the resource of interest 318. According to examples, the second set of embeddings 406 correspond to embeddings reflective of expected behavior of type A resources 118.

The anomaly detection system 110 depicted in FIG. 4 further includes a similarity engine 412. For instance, the similarity engine 412 determines a similarity measurement to measure the similarity between the embeddings 306 generated for the resource of interest 318 and the embeddings of other type A resources 118 using one or a combination of similarity measurements. For example, when the similarity measurement (e.g., similarity score) satisfies (e.g., is within) a similarity threshold, a determination 414 is made that the resource of interest 318 is stable (e.g., healthy). Alternatively, when the similarity measurement/score does not satisfy (e.g., is outside) the similarity threshold, a determination 414 is made that the resource of interest 318 is unstable (e.g., unhealthy).

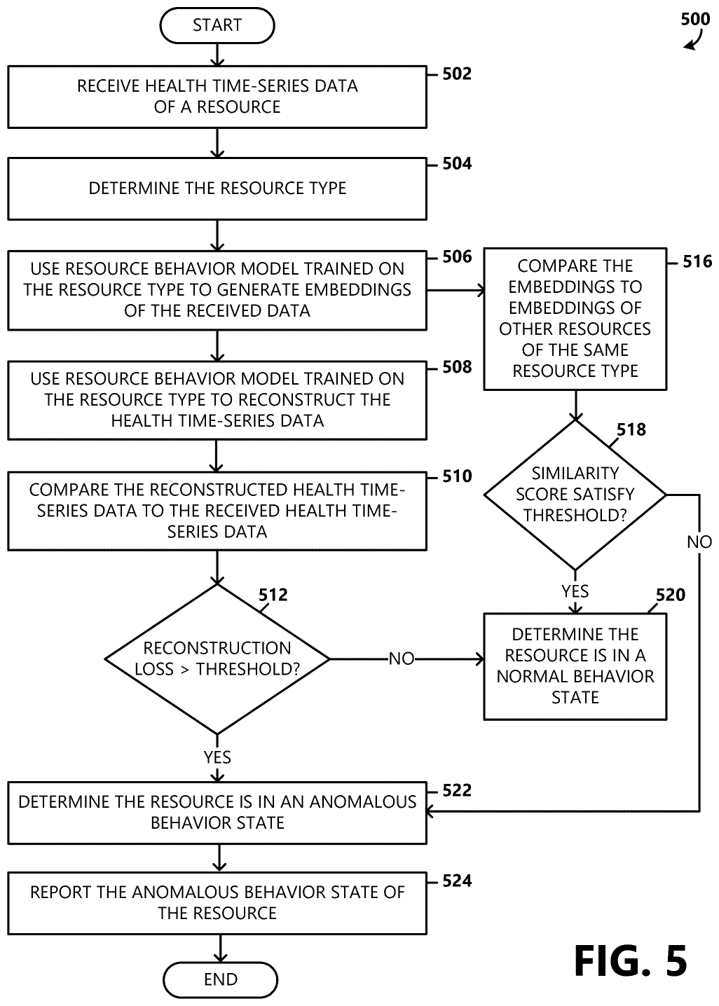

With reference now to FIG. 5, a flowchart depicting a method 500 for detecting an unstable resource 118 according to an example is provided. The operations of method 500 may be performed by one or more computing devices, such as the anomaly detection system 110. At operation 502, a set of health time-series data of a resource 118 is received. According to an example, the received health time-series data is represented as a vector time series of metrics, where the vector time series has a first dimension size.

At operation 504, a class or type of the resource 118 corresponding to the received health time-series data is determined based on one or more properties of the metric data (e.g., the resource, the namespace). At operation 506, a resource behavior model 120 that is trained on historical data of the determined resource type is selected and the encoder layer of the selected resource behavior model 120 is used to generate embeddings of the received health time-series data. In some examples, the resource behavior model 120 applies dimensional reduction to reduce the first dimension size of the vector time series to a second dimension size that is lower than the first dimension size.

At operation 508, the decoder layer of the resource behavior model 120 is used to convert the embeddings back to a reconstruction of the original received health time-series data. For example, the reconstructed health time-series data is represented as a vector time series of metrics, where the dimension size of the set of reconstructed health time series data is the same as the first dimension size of the received health time-series data.

At operation 510, the reconstructed health time-series data is compared to the received health time-series data and a reconstruction loss value is determined using one or a combination of loss functions. At decision operation 512, a determination is made as to whether the reconstruction loss value is above a loss threshold. When the reconstruction loss value is below the loss threshold, at operation 520, the resource 118 is determined to be operating in an expected behavior state. When the reconstruction loss value is above the loss threshold, the received health time-series data includes metrics that characterize anomalous resource behavior, and at operation 522, the resource 118 is determined to be operating in an anomalous behavior state.

Additionally or alternatively, after operation 506, the embeddings generated from the received health time-series data are compared to embeddings generated from health time-series data received in association with other resources 118 of the same resource type. In some examples, a measure of the similarity between the resource's embeddings and the embeddings of other resources is determined using one or a combination of similarity measurements.

At decision operation 518, a determination is made as to whether the similarity measurement/score satisfies a threshold value. When the similarity measurement does not satisfy (e.g., is outside) the similarity threshold, at operation 522, the anomaly detection system determines the resource 118 is operating in an anomalous behavior state. Alternatively, when the similarity measurement is within the similarity threshold, the resource is determined to be operating in an expected behavior state at operation 520. At operation 524, the anomalous behavior state(s) is/are reported. For example, an alert is generated indicating the resource 118 is possibly unstable.

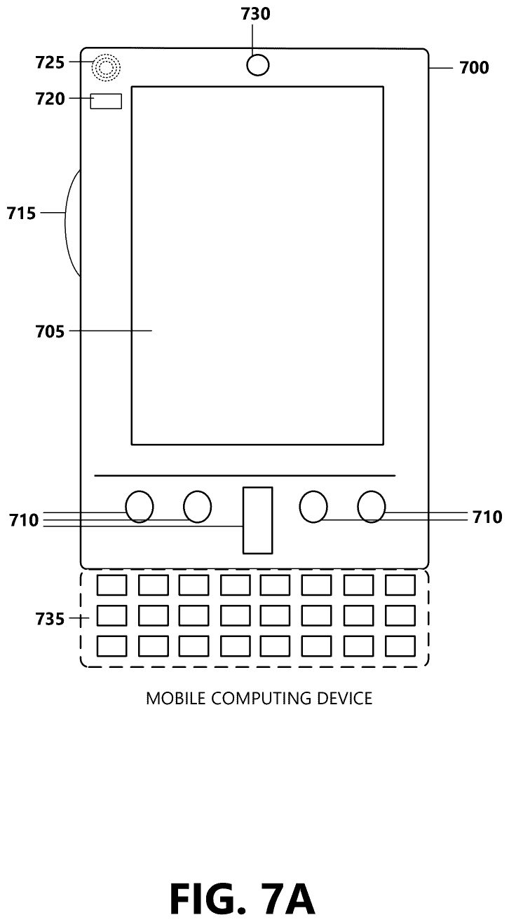

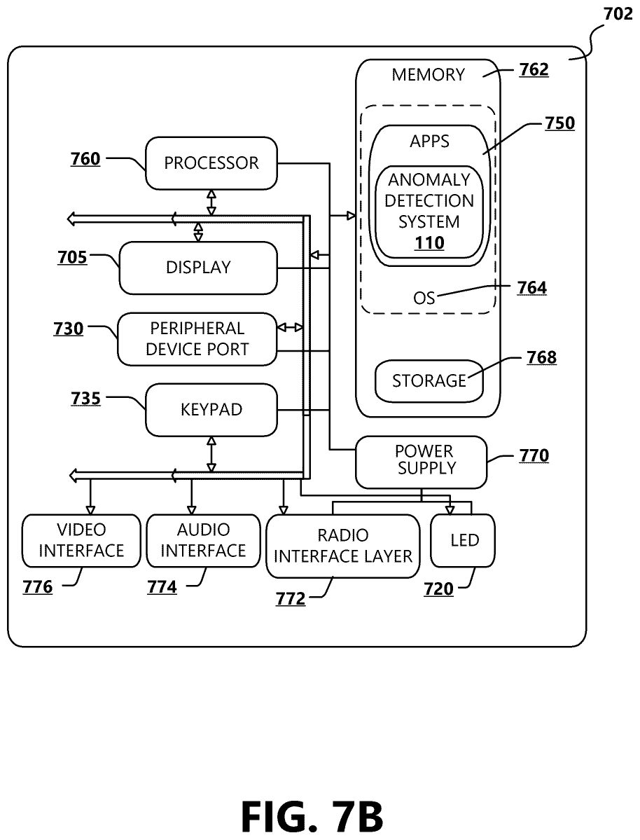

FIGS. 6, 7A, 7B, and 8 and the associated descriptions provide a discussion of a variety of operating environments in which examples of the disclosure may be practiced. However, the devices and systems illustrated and discussed with respect to FIGS. 66, 7A, 7B, and 8 are for purposes of example and illustration, a vast number of computing device configurations that may be utilized for practicing aspects of the disclosure, described herein.

FIG. 6 is a block diagram illustrating physical components (e.g., hardware) of a computing device 600 with which examples of the present disclosure may be practiced. The computing device components described below may be suitable for one or more of the components of the system 100 described above. In a basic configuration, the computing device 600 includes at least one processing unit 602 and a system memory 604. Depending on the configuration and type of computing device 600, the system memory 604 may comprise volatile storage (e.g., random access memory), non-volatile storage (e.g., read-only memory), flash memory, or any combination of such memories. The system memory 604 may include an operating system 605 and one or more program modules 606 suitable for running software applications 650, the anomaly detection system 110, and other applications.

The operating system 605 may be suitable for controlling the operation of the computing device 600. Furthermore, aspects of the disclosure may be practiced in conjunction with a graphics library, other operating systems, or any other application program and is not limited to any particular application or system. This basic configuration is illustrated in FIG. 6 by those components within a dashed line 608. The computing device 600 may have additional features or functionality. For example, the computing device 600 may also include additional data storage devices (removable and/or non-removable) such as, for example, magnetic disks, optical disks, or tape. Such additional storage is illustrated in FIG. 6 by a removable storage device 609 and a non-removable storage device 610.

As stated above, a number of program modules and data files may be stored in the system memory 604. While executing on the processing unit 602, the program modules 606 may perform processes including one or more of the stages of the method 500 illustrated in FIG. 5. Other program modules that may be used in accordance with examples of the present disclosure and may include applications such as electronic mail and contacts applications, word processing applications, spreadsheet applications, database applications, slide presentation applications, drawing or computer-aided application programs, etc.

Furthermore, examples of the disclosure may be practiced in an electrical circuit comprising discrete electronic elements, packaged or integrated electronic chips containing logic gates, a circuit utilizing a microprocessor, or on a single chip containing electronic elements or microprocessors. For example, examples of the disclosure may be practiced via a system-on-a-chip (SOC) where each or many of the components illustrated in FIG. 6 may be integrated onto a single integrated circuit. Such an SOC device may include one or more processing units, graphics units, communications units, system virtualization units and various application functionality all of which are integrated (or “burned”) onto the chip substrate as a single integrated circuit. When operating via an SOC, the functionality, described herein, with respect to detecting an unstable resource may be operated via application-specific logic integrated with other components of the computing device 600 on the single integrated circuit (chip). Examples of the present disclosure may also be practiced using other technologies capable of performing logical operations such as, for example, AND, OR, and NOT, including mechanical, optical, fluidic, and quantum technologies.

The computing device 600 may also have one or more input device(s) 612 such as a keyboard, a mouse, a pen, a sound input device, a touch input device, a camera, etc. The output device(s) 614 such as a display, speakers, a printer, etc. may also be included. The aforementioned devices are examples and others may be used. The computing device 600 may include one or more communication connections 616 allowing communications with other computing devices 618. Examples of suitable communication connections 616 include RF transmitter, receiver, and/or transceiver circuitry; universal serial bus (USB), parallel, and/or serial ports.

The term computer readable media as used herein includes volatile and nonvolatile, removable and non-removable media implemented in any method or technology for storage of information, such as computer readable instructions, data structures, or program modules. The system memory 604, the removable storage device 609, and the non-removable storage device 610 are all computer readable media examples (e.g., memory storage.) Computer readable media include random access memory (RAM), read-only memory (ROM), electrically erasable programmable ROM (EEPROM), flash memory or other memory technology, CD-ROM, digital versatile disks (DVD) or other optical storage, magnetic cassettes, magnetic tape, magnetic disk storage or other magnetic storage devices, or any other article of manufacture which can be used to store information and which can be accessed by the computing device 600. Any such computer readable media may be part of the computing device 600. Computer readable media does not include a carrier wave or other propagated data signal.

Communication media may be embodied by computer readable instructions, data structures, program modules, or other data in a modulated data signal, such as a carrier wave or other transport mechanism, and includes any information delivery media. The term “modulated data signal” may describe a signal that has one or more characteristics set or changed in such a manner as to encode information in the signal. By way of example, communication media may include wired media such as a wired network or direct-wired connection, and wireless media such as acoustic, RF, infrared, and other wireless media.

FIGS. 7A and 7B illustrate a mobile computing device 700, for example, a mobile telephone, a smart phone, a tablet personal computer, a laptop computer, and the like, with which aspects of the disclosure may be practiced. With reference to FIG. 7A, an example of a mobile computing device 700 for implementing at least some aspects of the present technology is illustrated. In a basic configuration, the mobile computing device 700 is a handheld computer having both input elements and output elements. The mobile computing device 700 typically includes a display 705 and one or more input buttons 710 that allow the user to enter information into the mobile computing device 700. The display 705 of the mobile computing device 700 may also function as an input device (e.g., a touch screen display). If included, an optional side input element 715 allows further user input. The side input element 715 may be a rotary switch, a button, or any other type of manual input element. In alternative examples, mobile computing device 700 may incorporate more or less input elements. For example, the display 705 may not be a touch screen in some examples. In alternative examples, the mobile computing device 700 is a portable phone system, such as a cellular phone. The mobile computing device 700 may also include an optional keypad 735. Optional keypad 735 may be a physical keypad or a “soft” keypad generated on the touch screen display. In various aspects, the output elements include the display 705 for showing a graphical user interface (GUI), a visual indicator 720 (e.g., a light emitting diode), and/or an audio transducer 725 (e.g., a speaker). In some examples, the mobile computing device 700 incorporates a vibration transducer for providing the user with tactile feedback. In yet another example, the mobile computing device 700 incorporates input and/or output ports, such as an audio input (e.g., a microphone jack), an audio output (e.g., a headphone jack), and a video output (e.g., a HDMI port) for sending signals to or receiving signals from an external device.

FIG. 7B is a block diagram illustrating the architecture of one example of a mobile computing device. That is, the mobile computing device 700 can incorporate a system (e.g., an architecture) 702 to implement some examples. In one example, the system 702 is implemented as a “smart phone” capable of running one or more applications (e.g., videoconference or virtual meeting application, browser, e-mail, calendaring, contact managers, messaging clients, games, and media clients/players). In some examples, the system 702 is integrated as a computing device, such as an integrated personal digital assistant (PDA) and wireless phone.

One or more application programs 750 (e.g., one or more of the components of system 100) may be loaded into the memory 762 and run on or in association with the operating system 764, such as the anomaly detection system 110. Other examples of the application programs 750 include videoconference or virtual meeting programs, phone dialer programs, e-mail programs, personal information management (PIM) programs, word processing programs, spreadsheet programs, Internet browser programs, messaging programs, and so forth. The system 702 also includes a non-volatile storage area 768 within the memory 762. The non-volatile storage area 768 may be used to store persistent information that should not be lost if the system 702 is powered down. The application programs 750 may use and store information in the non-volatile storage area 768, such as e-mail or other messages used by an e-mail application, and the like. A synchronization application (not shown) also resides on the system 702 and is programmed to interact with a corresponding synchronization application resident on a host computer to keep the information stored in the non-volatile storage area 768 synchronized with corresponding information stored at a remote device or server. As should be appreciated, other applications may be loaded into the memory 762 and run on the mobile computing device 700.

The system 702 has a power supply 770, which may be implemented as one or more batteries. The power supply 770 might further include an external power source, such as an AC adapter or a powered docking cradle that supplements or recharges the batteries.

The system 702 may also include a radio 772 that performs the function of transmitting and receiving radio frequency (RF) communications. The radio 772 facilitates wireless connectivity between the system 702 and the “outside world,” via a communications carrier or service provider. Transmissions to and from the radio 772 are conducted under control of the operating system 764. In other words, communications received by the radio 772 may be disseminated to the application programs 750 via the operating system 764, and vice versa.

The visual indicator 720 (e.g., light emitting diode (LED)) may be used to provide visual notifications and/or an audio interface 774 may be used for producing audible notifications via the audio transducer 725. In the illustrated example, the visual indicator 720 is a light emitting diode (LED) and the audio transducer 725 is a speaker. These devices may be directly coupled to the power supply 770 so that when activated, they remain on for a duration dictated by the notification mechanism even though the processor 760 and other components might shut down for conserving battery power. The LED may be programmed to remain on indefinitely until the user takes action to indicate the powered-on status of the device. The audio interface 774 is used to provide audible signals to and receive audible signals from the user. For example, in addition to being coupled to the audio transducer 725, the audio interface 774 may also be coupled to a microphone to receive audible input, such as to facilitate a telephone conversation. The system 702 may further include a video interface 776 that enables an operation of a peripheral device port 730 (e.g., an on-board camera) to record still images, video stream, and the like.

A mobile computing device 700 implementing the system 702 may have additional features or functionality. For example, the mobile computing device 700 may also include additional data storage devices (removable and/or non-removable) such as, magnetic disks, optical disks, or tape. Such additional storage is illustrated in FIG. 7B by the non-volatile storage area 768.

Data/information generated or captured by the mobile computing device 700 and stored via the system 702 may be stored locally on the mobile computing device 700, as described above, or the data may be stored on any number of storage media that may be accessed by the device via the radio 772 or via a wired connection between the mobile computing device 700 and a separate computing device associated with the mobile computing device 700, for example, a server computer in a distributed computing network, such as the Internet. As should be appreciated such data/information may be accessed via the mobile computing device 700 via the radio 772 or via a distributed computing network. Similarly, such data/information may be readily transferred between computing devices for storage and use according to well-known data/information transfer and storage means, including electronic mail and collaborative data/information sharing systems.

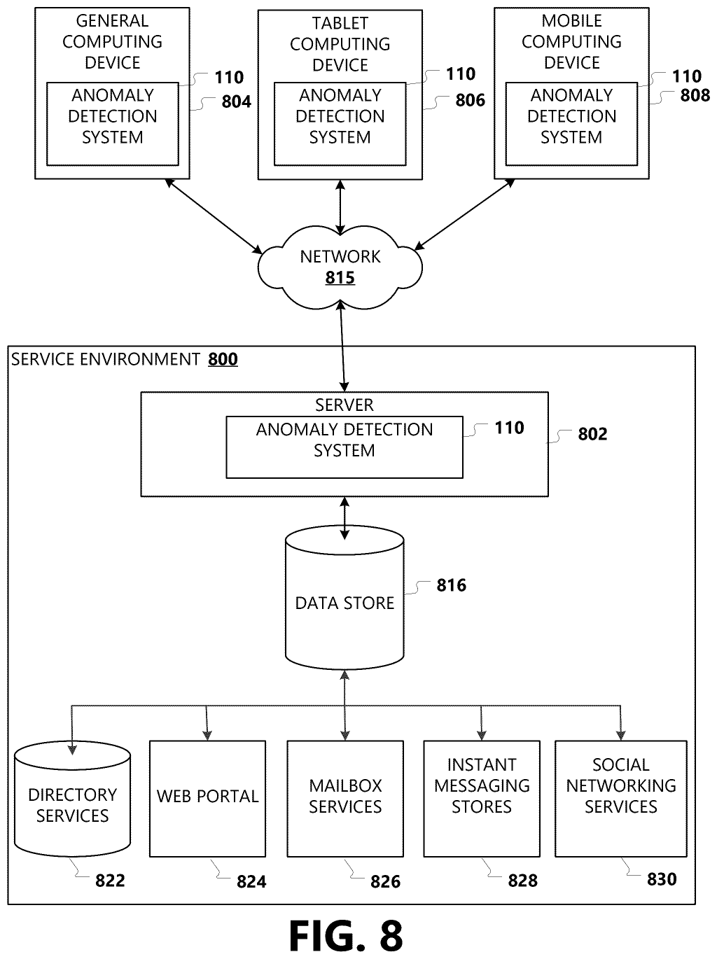

FIG. 8 illustrates one aspect of the architecture of a system for processing data received at a service environment 800 from a remote source, such as a personal computer 804, tablet computing device 806, or a mobile computing device 808. Content received and/or displayed at server device 802 may be stored in different communication channels or other storage types. For example, various documents may be stored using directory services 822, web portals 824, mailbox services 826, instant messaging stores 828, or social networking services 830.

An anomaly detection system 820 may be implemented by a remote source that communicates with server device 802 and/or anomaly detection system 110 may be implemented by server device 802. The server device 802 provides data to and from a remote source through a network 815. In one example, server device 802 receives information associated with resource events from a remote source and transmits notifications regarding behavior of resources to the remote source. In another example, server device 802 receives data for training a resource behavior model from a remote source and transmits a copy of the trained resource behavior model (or an indication thereof) to a remote source and/or to a component of service environment 800.

Examples include a computer-implemented method, comprising: receiving a first set of resource health data from a first resource, where the first resource is of a first resource type; encoding the first set of resource health data into a first set of embeddings using a first machine learning embedding model; reconstructing the first set of embeddings into a reconstructed first set of resource health data using the first machine learning embedding model; comparing the reconstructed first set of resource health data to the first set of resource health data; determining a loss value between the reconstructed first set of resource health data and the first set of resource health data is above a threshold distance; and in response to determining that the loss value is above the threshold distance, determining the first set of resource health data includes metrics corresponding to anomalous resource behavior.

Examples further include a system, comprising: a processing system; and memory storing instructions that, when executed by the processing system, cause the system to: encode a first set of resource health data into a first set of embeddings using a first machine learning embedding model, the first set of resource health data being from a first resource of a first resource type; reconstruct the first set of embeddings into a reconstructed first set of resource health data using the first machine learning embedding model; compare the reconstructed first set of resource health data to the first set of resource health data; determine a loss between the reconstructed first set of resource health data and the first set of resource health data is above a threshold distance; and in response to determining the loss is above the threshold distance, determine the first set of resource health data includes metrics corresponding to anomalous resource behavior.

Examples further include a computer-readable medium storing instructions that, when executed by a computer, cause the computer to: receive historical resource health data of a first resource type of a plurality of resource types from a plurality of resources; train a machine learning embedding model to predict normal temporal metric behavior based on the historical resource health data of the first resource type; receive a first set of resource health data from a first resource, where the first resource is of the first resource type; encode the first set of resource health data into a first set of embeddings using the machine learning embedding model; reconstruct the first set of embeddings into a reconstructed first set of resource health data using the machine learning embedding model; determine a loss between the reconstructed first set of resource health data and the first set of resource health data is above a threshold distance; and based on determining the loss is above the threshold distance, determine the first set of resource health data includes metrics corresponding to anomalous resource behavior.

It is to be understood that the methods, modules, and components depicted herein are merely examples. Alternatively, or in addition, the functionality described herein can be performed, at least in part, by one or more hardware logic components. For example, illustrative types of hardware logic components that can be used include Field-Programmable Gate Arrays (FPGAs), Application-Specific Integrated Circuits (ASICs), Application-Specific Standard Products (ASSPs), System-on-a-Chip systems (SOCs), Complex Programmable Logic Devices (CPLDs), etc. In an abstract, but still definite sense, any arrangement of components to achieve the same functionality is effectively “associated” such that the desired functionality is achieved. Hence, any two components herein combined to achieve a particular functionality can be seen as “associated with” each other such that the desired functionality is achieved, irrespective of architectures or inter-medial components. Likewise, any two components so associated can also be viewed as being “operably connected,” or “coupled,” to each other to achieve the desired functionality. Merely because a component, which may be an apparatus, a structure, a system, or any other implementation of a functionality, is described herein as being coupled to another component does not mean that the components are necessarily separate components. As an example, a component A described as being coupled to another component B may be a sub-component of the component B, the component B may be a sub-component of the component A, or components A and B may be a combined sub-component of another component C.

The functionality associated with some examples described in this disclosure can also include instructions stored in a non-transitory media. The term “non-transitory media” as used herein refers to any media storing data and/or instructions that cause a machine to operate in a specific manner. Illustrative non-transitory media include non-volatile media and/or volatile media. Non-volatile media include, for example, a hard disk, a solid-state drive, a magnetic disk or tape, an optical disk or tape, a flash memory, an EPROM, NVRAM, PRAM, or other such media, or networked versions of such media. Volatile media include, for example, dynamic memory such as DRAM, SRAM, a cache, or other such media. Non-transitory media is distinct from, but can be used in conjunction with transmission media. Transmission media is used for transferring data and/or instruction to or from a machine. Examples of transmission media include coaxial cables, fiber-optic cables, copper wires, and wireless media, such as radio waves.

Furthermore, those skilled in the art will recognize that boundaries between the functionality of the above described operations are merely illustrative. The functionality of multiple operations may be combined into a single operation, and/or the functionality of a single operation may be distributed in additional operations. Moreover, alternative embodiments may include multiple instances of a particular operation, and the order of operations may be altered in various other embodiments.

Although the disclosure provides specific examples, various modifications and changes can be made without departing from the scope of the disclosure as set forth in the claims below. Accordingly, the specification and figures are to be regarded in an illustrative rather than a restrictive sense, and all such modifications are intended to be included within the scope of the present disclosure. Any benefits, advantages, or solutions to problems that are described herein with regard to a specific example are not intended to be construed as a critical, required, or essential feature or element of any or all the claims.

Furthermore, the terms “a” or “an,” as used herein, are defined as one or more than one. Also, the use of introductory phrases such as “at least one” and “one or more” in the claims should not be construed to imply that the introduction of another claim element by the indefinite articles “a” or “an” limits any particular claim containing such introduced claim element to containing only one such element, even when the same claim includes the introductory phrases “one or more” or “at least one” and indefinite articles such as “a” or “an.” The same holds true for the use of definite articles.

Unless stated otherwise, terms such as “first” and “second” are used to arbitrarily distinguish between the elements such terms describe. Thus, these terms are not necessarily intended to indicate temporal or other prioritization of such elements.

What is claimed is:

1. A system comprising:
a processor; and
memory comprising computer executable instructions that, when executed, perform operations comprising:
receiving first resource health data from a first resource having a resource type;
generating first embeddings of the first resource health data by providing the first resource health data to a resource behavior model trained on the resource type;
calculating a similarity measurement between the first embeddings and second embeddings of second resource health data received from a set of second resources having the resource type by comparing the first embeddings to the second embeddings;
in response to determining the similarity measurement does not satisfy a similarity threshold value, determining the first resource in operating in an anomalous behavior state; and
reporting the anomalous behavior state.

2. The system of claim 1, wherein the first resource health data is represented as a vector time series of metrics collected at regular intervals.

3. The system of claim 1, wherein generating the first embeddings comprises generating weighted vectors representing relationships between metrics included in the first resource health data.

4. The system of claim 1, wherein:
the first resource health data has a first dimension size; and
generating first embeddings comprises reducing the first dimension size to a second dimension size that is smaller than the first dimension size.

5. The system of claim 1, wherein the resource behavior model:
includes an encoder for generating the first embeddings; and
does not include a decoder for decoding the first embeddings.

6. The system of claim 1, wherein the second embeddings are collected from an embeddings library external to the system.

7. The system of claim 1, wherein the second embeddings correspond to embeddings reflective of expected behavior of the resource type.

8. The system of claim 1, wherein calculating the similarity measurement comprises:
utilizing a similarity engine of the system to measure similarity between the first embeddings and the second embeddings.

9. The system of claim 1, wherein the similarity measurement is a Euclidean distance or cosine similarity.

10. The system of claim 1, wherein the resource type is a machine learning (ML) resource.

11. The system of claim 1, wherein the resource type is an analytics resource or a storage resource.

12. A method comprising:
receiving, by an anomaly detection system of a computing device, first resource health data from a first resource having a first resource type;
generating, by the anomaly detection system, first embeddings of the first resource health data by providing the first resource health data to a first resource behavior model trained on the first resource type;
calculating, by the anomaly detection system, a first similarity measurement between the first embeddings and second embeddings of second resource health data received from a set of second resources having the first resource type by comparing the first embeddings to the second embeddings;
in response to determining the first similarity measurement satisfies a similarity threshold value, determining, by the anomaly detection system, the first resource in operating in an anomalous behavior state; and
reporting, by the anomaly detection system, the anomalous behavior state.

13. The method of claim 12, wherein the first resource behavior model is trained by a machine learning training engine of the anomaly detection system.

14. The method of claim 12, wherein the first resource behavior model is trained on historical health time-series data of resources of the first resource type.

15. The method of claim 12, wherein the anomaly detection system further comprises a second resource behavior model trained on historical health time-series data of resources of a second resource type.

16. The method of claim 15, further comprising:
receiving, by the anomaly detection system, third resource health data from a third resource having the second resource type;
generating, by the anomaly detection system, third embeddings of the third resource health data by providing the third resource health data to the second resource behavior model;
calculating, by the anomaly detection system, a second similarity measurement between the third embeddings and fourth embeddings of fourth resource health data received from a set of fourth resources having the second resource type by comparing the third embeddings to the fourth embeddings; and
determining whether the second similarity measurement satisfies the similarity threshold value.

17. A device comprising:
a processor; and
memory comprising computer executable instructions that, when executed, perform operations comprising:
receiving, by an anomaly detection system of the device, first resource health data from a first resource having a first resource type;
generating, by the anomaly detection system, first embeddings of the first resource health data by providing the first resource health data to a first resource behavior model trained on the first resource type;
calculating, by the anomaly detection system, a first similarity measurement between the first embeddings and second embeddings of second resource health data received from a set of second resources having the first resource type by comparing the first embeddings to the second embeddings;
in response to determining the first similarity measurement satisfies a similarity threshold value, determining, by the anomaly detection system, the first resource in operating in an anomalous behavior state; and
reporting, by the anomaly detection system, the anomalous behavior state.

18. The device of claim 17, the operations further comprising:
prior to receiving, by the anomaly detection system, the first resource health data:
monitoring, by a health analyzer of the device, the first resource health data; and
performing, by the health analyzer, a temporal anomaly analysis to detect anomalous points in time where the first resource is suspected of being unstable.

19. The device of claim 18, the operations further comprising:
based on the temporal anomaly analysis, generating, by the health analyzer, an incident report that provides information about a diagnosed resource event for the first resource; and
performing, by the health analyzer, a root cause analysis for the resource event.

20. The device of claim 19, the operations further comprising:
after performing, by the health analyzer, the root cause analysis, validating the root cause analysis by executing the anomaly detection system.
